(19) United States
(12) Patent Application Publication
(10) Pub. No.: US 2024/0009783 A1
(43) Pub. Date: Jan. 11, 2024

(54) SAFE SCREWING DEVICE HAVING COMPLIANCE MECHANISM

(71) Applicant: Spin Robotics ApS, Odense SØ (DK)

(72) Inventors: Thomas SØLUND, Odense M (DK); Sami Frølund JARRAR, Odense N (DK)

(73) Assignee: Spin Robotics ApS, Odense SØ (DK)

(21) Appl. No.: 18/040,232

(22) PCT Filed: Jul. 7, 2021
(86) PCT No.: PCT/EP2021/068859

§ 371 Date: Feb. 1, 2023

(30) Foreign Application Priority Data
Aug. 3, 2020 (DK) PA202000886
Aug. 3, 2020 (DK) PA202000887

(51) Int. Cl. B23P 19/00; B23P 19/06; B25J 11/00; B25J 19/06

(52) U.S. Cl. CPC B23P 19/006; B23P 19/06; B25J 11/005; B25J 19/06

(57) ABSTRACT

A screwing device including a connection portion configured to be detachably attached to a robot arm and a housing and a screw holding portion fixed to the housing. The screw holding portion is configured to hold a screw and bring the screw into contact with a screw hole of an object arranged in a predefined position. The screwing device includes a motor arranged to rotate the screw holding portion with respect to its longitudinal axis. The screwing device includes an alert unit configured to allow the screw holding portion to be moved away from a structure when the force by which the structure presses against the screw holding portion or a screw held by the screw holding portion exceeds a predefined level. The alert unit configured to bring the screwing device into a failure mode, in which the motor is turned off when the force exceeds the predefined level.

### FIELD OF INVENTION

The present invention relates to a screwing device for a robot. The present invention more particularly relates to a screwing device for a collaborative robot.

### PRIOR ART

Screwing processes are essential in many industrial applications. In many industrial applications manual and repetitive screwing tasks carried out. Accordingly, several screwing devices have been developed for industrial assembly of screws, bolts and nuts. The prior art screwing devices, however, are complex and unsuitable for being used in many applications.

Thus, there is a need for a safe screwing method and screwing device for a collaborative robot which reduces or even eliminates the above-mentioned disadvantages of the prior art.

It is an object of the invention to provide a safe and user-friendly screwing device for a collaborative robot and a method for using such screwing device.

### SUMMARY OF THE INVENTION

The object of the present invention can be achieved by a screwing device as defined in claim 1 and by a method as defined in claim 9. Preferred embodiments are defined in the dependent subclaims, explained in the following description and illustrated in the accompanying drawings.

The screwing device according to the invention is a screwing device comprising a connection portion configured to be detachably attached to a robot arm, wherein the screwing device comprises a housing and a screw holding portion fixed to the housing, wherein the screw holding portion is configured to hold a screw in such a manner that the screw can be brought into contact with a screw hole of an object arranged in a predefined position, wherein the screwing device comprises a motor arranged to rotate the screw holding portion with respect to its longitudinal axis, wherein the screwing device comprises an alert unit configured to allow the screw holding portion to be moved away from a structure when the force, by which the structure presses against the screw holding portion or a screw held by the screw holding portion exceeds a predefined level, wherein the alert unit configured to bring the screwing device into a failure mode, in which the motor is turned off when the force exceeds the predefined level.

Hereby, it is possible to provide a simple, reliable and safe screwing device for a collaborative robot.

The screwing device according to the invention is a screwing device comprising a connection portion configured to be detachably attached to a robot arm. In one embodiment, the connection portion is configured to be directly attached to the robot arm.

In a preferred embodiment, the screwing device comprises a connection portion that is configured to be detachably attached to a robot arm by means of a coupling.

The screwing device comprises a housing and a screw holding portion fixed to the housing, wherein the screw holding portion is configured to hold a screw in such a manner that the screw can be brought into contact with a screw hole of an object arranged in a predefined position.

The screwing device comprises a motor arranged to rotate the screw holding portion with respect to its longitudinal axis. In one embodiment, this motor is a gear motor.

The alert unit is configured to allow the screw holding portion to be moved away from the structure when the force, by which an object presses against the screw holding portion or a screw held by the screw holding portion exceeds a predefined level, wherein the alert unit configured to bring the screwing device into a failure mode, in which the motor is turned off when the force exceeds the predefined level.

Typically, the robot arm is arranged to move the screw holding portion in such a manner that the screw is brought into contact with a screw hole of an object arranged in a predefined position. Accordingly, the screwing device is configured to rotate the screw holding portion, while displacement of the screw along the longitudinal axis of the screw can be carried out by using the robot arm.

The screwing device is configured to allow the screw holding portion to be passively moved away from the structure. Accordingly, no actuator is required to move the screw holding portion.

Moving the screw holding portion away from the structure requires that the screw holding portion or a screw held by the screw holding portion is brought into contact with a structure and that the force by which the structure presses against the screw holding portion or a screw held by the screw holding portion exceeds a predefined level. This means that if the force by which a screw presses against the screw holding portion exceeds a predefined level due to a damaged screw hole thread, the screw holding portion will be moved away from the structure. Likewise, the screw holding portion will be moved away from the structure in case that an undesired/unplanned contact with a structure (e.g. a hand) causes that the force, by which the structure presses against the screw holding portion or a screw held by the screw holding portion exceeds a predefined level.

In one embodiment the predefined level is 60 Newton or less.

In one embodiment the predefined level is 50 Newton or less.

In one embodiment the predefined level is 40 Newton or less.

In one embodiment the predefined level is 40 Newton.

It may be an advantage that the alert unit is configured to turn off the motor when the screw holding portion or a screw held by the screw holding portion is brought into contact with a structure (e.g. a second object). Turning off the motor may be accomplished by using a control unit integrated in the screwing device. In another embodiment, however, turning off the motor may be accomplished by using an external control system, preferably the control system of the robot, to which the screwing device is connected.

In a preferred embodiment, the screwing device comprises a control unit configured to detect when the force, by which a structure presses against the screw holding portion or a screw held by the screw holding portion exceeds a predefined level, wherein the control unit is connected to the control system of the robot and thus configured to inform the control system of the robot when the force, by which the subject presses against the screw holding portion or a screw held by the screw holding portion exceeds a predefined level. Accordingly, the control system of the robot can be used to turn off the motor(s) of the screwing device as long as the force, by which the structure presses against the screw holding portion or a screw held by the screw holding portion exceeds a predefined level.

In a preferred embodiment, the screwing device is configured to allow the screw holding portion to be moved in a direction along the longitudinal axis of the screw holding portion.

By the term “screw” is meant any fastening means that needs to be fastened by a rotational motion. Accordingly, the term “screw” includes screws, bolts and nuts.

In one embodiment, the screwing device comprises a linear translation unit comprising a slide member slidably arranged in a track, wherein the slide member is rigidly attached to the robot arm. Hereby, it is possible to provide a simple and reliable mechanical compliant mechanism.

The slide member may either be directly attached to the robot arm or be attached to a coupling that is attached to the robot arm.

In one embodiment, the track extends along the axis of movement of the screw holding portion. Hereby, it is possible to perform the most efficient and fast movement of the screw holding portion.

In one embodiment, the linear translation unit comprises one or more spring(s) arranged to displace the slide member along the longitudinal axis of the track. Hereby, the spring(s) will provide a force that ensure that the screwing operation can be carried out. Moreover, the spring(s) will press against the slide member and hereby displace the housing back in place (by moving the house and the screw holding portion along the longitudinal axis of the screw holding portion) when the screwing device has to be operated in normal operation mode after the alert unit has be activated.

In one embodiment, the housing is slidably attached to connection portion. Hereby, the entire housing can be moved away from a structure when the screwing device is operated in fail mode (which is when the alert unit detects contact with the structure (e.g. a second object)).

In one embodiment, screwing device comprises a base structure forming part of the housing, wherein the base structure is slidably attached to the slide member that is rigidly attached to the robot arm. The base structure may be arranged at a side portion of the housing.

In one embodiment, the screwing device comprises a slidably arranged safety sleeve configured to be moved along the longitudinal axis of the holding portion, wherein the screwing device comprises a motor and a mechanical transfer unit arranged in the housing, wherein the mechanical transfer unit is arranged to displace the safety sleeve along the longitudinal axis of the holding portion.

In one embodiment, the motor is a stepper motor.

In a preferred embodiment, a motor configured to rotate the holding portion is arranged in the housing.

It may be an advantage that the motor configured to rotate the holding portion is a gear motor.

In one embodiment, a safety sensor is arranged in the housing, wherein the safety sensor is arranged to detect when the safety sensor is displaced along the longitudinal axis of the screw holding portion.

In one embodiment, the safety sensor is arranged and configured to detect when the housing is displaced along the longitudinal axis of the screw holding portion with respect to the connection portion.

In one embodiment, the safety sensor is an inductive sensor configured to detect when a distal portion of the safety sensor is within close proximity of metal. When the housing is displaced along the longitudinal axis of the screw holding portion, the distal portion of the sensor is no longer within close proximity of the metal of the coupling.

The safety sensor is configured to turn off the motor rotating the screw holding portion.

In one embodiment, the screwing device comprises a free drive (neutral gear) button, wherein the free drive button is configured to electrically communicate with the robot arm and bring the robot arm in a free drive (neutral gear) configuration, in which the robot arm can be moved freely by the operator.

In one embodiment, the free drive (neutral gear) button is accessible from outside the housing.

In one embodiment, the free drive (neutral gear) button protrudes from the housing.

In one embodiment, the free drive (neutral gear) button is integrated in the housing.

The screwing device is configured to be operated in an operation mode, in which screwing operations can be carried out.

The screwing device is configured to be brought into a failure mode, in which the screwing device has been deactivated. Deactivation of the screwing device and in particularly the motor rotating the screw holding portion is carried by means of the alert unit. It is important to underline that deactivation of the motors of the screwing device may be carried out either directly by using an integrated control unit that is configured to deactivate the motors or by using the control system of the robot to which the screwing device is connected.

The method according to the invention is a method for using a screwing device comprising a connection portion configured to be detachably attached to a robot arm to conduct a safe screwing operation, wherein the screwing device comprises a housing and a screw holding portion fixed to the housing, wherein the screw holding portion is configured to hold a screw and bring the screw into contact with a screw hole of an object arranged in a predefined position, wherein the screwing device comprises a motor arranged to rotate the screw holding portion with respect to its longitudinal axis, wherein the method comprises the steps of:
allowing the screw holding portion to be moved away from a structure when the force, by which the structure presses against the screw holding portion or a screw held by the screw holding portion exceeds a predefined level;
brining the screwing device into failure mode, in which the motor is turned off when the force exceeds the predefined level.

Hereby, it is possible to provide a simple, reliable and safe method for using screwing device for a collaborative robot.

In one embodiment, the method applies a screwing device according to the invention.

The connection portion may be detachably attached directly to a robot arm. However, the connection portion may be detachably attached a coupling that is attached to the robot arm.

The method provides a safe screwing operation by carrying out the steps of:
allowing the screw holding portion to be moved away from the object when the force, by which the structure presses against the screw holding portion or a screw held by the screw holding portion exceeds a predefined level;
bringing the screwing device into failure mode, in which the motor is turned off when the force exceeds the predefined level.

In one embodiment, the method comprises the step of allowing the screw holding portion to be moved away in a direction along the longitudinal axis of the screw holding portion. Hereby, a fast movement of the screw holding portion can be achieved.

By using the method, the screw holding portion is allowed to be passively moved away from the structure. The motion is carried out without using any actuator. The force, by which the structure presses against the screw holding portion or a screw held by the screw holding portion determines if the screw holding portion moved away from the structure. If the force, by which the structure presses against the screw holding portion or a screw held by the screw holding portion is smaller than the predefined level, the screw holding portion will not be moved away from the structure. If the force, by which the structure presses against the screw holding portion or a screw held by the screw holding portion is larger than the predefined level, and hereafter is reduced to a level below the predefined level, the screw holding portion will be moved back (towards the structure) passively.

In one embodiment, the method comprises the step of moving the screw holding portion away from the structure when the force, by which the structure presses against the screw holding portion or a screw held by the screw holding portion exceeds a predefined level by means of a linear translation unit comprising a slide member slidably arranged in a track, wherein the slide member is rigidly attached to the robot arm. This solution is simple, reliable and practical.

It may be an advantage that the method comprises the step of applying a track that extends along the axis of movement of the screw holding portion. This orientation would be optimum in order to provide the fastest possible retraction.

It may be an advantage that the method comprises the step of applying a linear translation unit that comprises one or more springs arranged to displace the slide member along the longitudinal axis of the track. Hereby, the spring(s) can provide a force that ensure that the screwing operation can be carried out. Moreover, the spring(s) will press against the slide member and hereby displace the housing back in place (by moving the house and the screw holding portion along the longitudinal axis of the screw holding portion) when the screwing device has to be operated in normal operation mode after the alert unit has been activated.

It may be beneficial that the method comprises the step of applying a housing that is slidably attached to connection portion.

In one embodiment, the method comprises the step of applying a screwing device comprises a base structure forming part of the housing, wherein the base structure is slidably attached to the slide member that is rigidly attached to the robot arm.

In one embodiment, the method comprises the step of applying a slidably arranged safety sleeve configured to be moved along the longitudinal axis of the holding portion, wherein the screwing device comprises a stepper motor and a mechanical transfer unit arranged in the housing, wherein the mechanical transfer unit is arranged to displace the safety sleeve along the longitudinal axis of the holding portion. Hereby, access from the outside to a rotating screw can be avoided and thus a safe solution can be provided.

In one embodiment, the method comprises the step of applying a gear motor configured to rotate the holding portion is arranged in the housing.

In one embodiment, the method comprises the step of applying a safety sensor arranged to detect when the safety sensor is displaced along the longitudinal axis of the screw holding portion.

In one embodiment, the method comprises the step of applying a safety sensor arranged in the housing, wherein the safety sensor is arranged to detect when the safety sensor is displaced along the longitudinal axis of the screw holding portion.

In one embodiment, the method comprises the step of applying an inductive sensor configured to detect when the distal portion of the safety sensor is within close proximity to metal.

In one embodiment, a free drive (neutral gear) button is provided at the housing and being configured to electrically communicate with the robot arm.

The method allows the screwing device to be operated in an operation mode, in which screwing operations can be carried out.

The method, moreover, allows the screwing device to be brought into a failure mode, in which the screwing device has been deactivated. Deactivation of the screwing device and in particularly the motor rotating the screw holding portion is carried by means of the alert unit.

The object of the present invention may furthermore be achieved by a screwing device as defined in claim 13 and by a method as defined in claim 20. Preferred embodiments are defined in the dependent subclaims 14-19 and 21-23, explained in the following description and illustrated in the accompanying drawings.

In one embodiment, the screwing device comprises a connection portion configured to be detachably attached to a robot arm, wherein the screwing device comprises a housing and a screw holding portion fixed to the housing, wherein the screw holding portion is configured to hold a screw and bring the screw into contact with a screw hole of an object arranged in a predefined position, wherein the screwing device comprises a motor arranged to rotate the screw holding portion with respect to its longitudinal axis, wherein the screwing device comprises a slidably arranged safety sleeve configured to be moved along the longitudinal axis of the screw holding portion, wherein a sensor configured to detect the presence of a screw in the screw holding portion is arranged in the distal end of the safety sleeve.

Hereby, it is possible to provide an even more safe screwing device for a collaborative robot. The safety sleeve will protect the user of the screwing device against damage caused by contact with a rotating screw.

In one embodiment, the sensor is a Hall sensor. Hereby, detection of the screw can be carried out in a simple and reliable manner.

In one embodiment, a permanent magnet is provided in the distal end of the screw holding portion. Hereby, the magnetic field of the permanent magnet can be extended along the length of the screw if the screw is made in a material suitable for this. Accordingly, the use of a permanent magnet provided in the distal end of the screw holding portion is a simple, reliable and practical solution.

In one embodiment, screw holding portion comprises a bit holder provided at the distal end of the screw holding portion.

In one embodiment, the permanent magnet is ring-shaped.

In one embodiment, the permanent magnet is centrally arranged with respect to the longitudinal axis of the screw holding portion.

In one embodiment, the bit holder comprises a cylindrical portion, wherein a cylindrical permanent magnet is arranged inside the cylindrical portion. Hereby, it is possible to minimise the radial distance between the permanent magnet and the screw. At the same time, the permanent magnet can be protected by the cylindrical portion surrounding it radially.

In one embodiment, the screwing device comprises a motor arranged and configured to displace the safety sleeve configured to be moved along the longitudinal axis of the screw holding portion.

In one embodiment, a mechanical connection unit is arranged to mechanically transfer power from the motor to one or more structures arranged and configured to displace the safety sleeve.

In one embodiment, the motor is a stepper motor.

In one embodiment, the screwing device comprises a control unit electrically connected to the Hall sensor.

The control unit may be arranged inside the housing of the screwing device.

In one embodiment, the control unit is electrically connected to a motor of the screwing device.

In a one embodiment, the control unit is electrically connected to all motors of the screwing device.

In one embodiment, the control unit is electrically connected to the control system of the robot.

In one embodiment, the method is a method for using a screwing device comprising a connection portion configured to be detachably attached to a robot arm to conduct a safe screwing operation, wherein the screwing device comprises a housing and a screw holding portion fixed to the housing, wherein the method comprises the step of detecting if a screw is present in the screw holding portion.

Hereby, it is possible to provide a safe method for using a screwing device for a collaborative robot. The safety sleeve will protect the user of the screwing device against damage caused by contact with a rotating screw.

In one embodiment, the step of detecting if a screw is present in the screw holding portion is carried out by means of a sensor arranged at the distal end of the safety sleeve.

In a preferred embodiment, the sensor is a Hall sensor.

In one embodiment, the method comprises the steps of:
transmitting sensor signals detected by the sensor to a control unit of the screwing device and
using the control unit to control one or more motors of the screwing device.

Hereby, it is possible to control the one or more motors in dependency of the sensor signals detected by the sensor.

By the term “control” is meant starting, stopping and otherwise changing the activity of the one or more motors.

In one embodiment, the method comprises the step of instructing the robot to pick-up a new screw if the sensor has detected that no screw is held by the screw holding portion.

In one embodiment, the method comprises the steps of:
instructing the robot arm to move the screwing device into a position in which the screwing device can pick-up a screw if the sensor has detected that no screw is held by the screw holding portion and
picking-up a screw.

In one embodiment, the method comprises the steps of:
providing information about the length and/or material characteristics of a screw and
positioning the safety sleeve into a position in which the sensor is expected to detect the present of the screw having the provided length and/or material characteristics.

Hereby, the method takes into consideration the characteristic of the screw and places the safety sleeve in an optimum position with the purpose of detecting the presents of screw in the screw holding portion.

### DESCRIPTION OF THE DRAWINGS

The invention will become more fully understood from the detailed description given herein below. The accompanying drawings are given by way of illustration only, and thus, they are not limitative of the present invention. In the accompanying drawings:

FIG. 1A shows a side view of a screwing device according to the invention in operation mode;

FIG. 1B shows a perspective side view of the screwing device shown in FIG. 1B in operation mode;

FIG. 2A shows a side view of the screwing device according to the invention in a fail mode, in which the screwing device has been deactivated;

FIG. 2B shows a perspective side view of the screwing device shown in FIG. 1A;

FIG. 3A shows a side view of a screwing device according to the invention;

FIG. 3B shows a close-up view of the screwing device shown in FIG. 3A;

FIG. 4A shows a perspective side view of a screwing device according to the invention;

FIG. 4B shows a close-up view of the screwing device shown in FIG. 4A;

FIG. 5A shows the distal portion of a screw holding portion of a screwing device according to the invention in a first configuration;

FIG. 5B shows the distal portion of a screw holding portion of a screwing device according to the invention in a second configuration;

FIG. 5C shows a close-up perspective view of the distal portion of the bit holder of the screw holding portion shown in FIG. 5A and FIG. 5B;

FIG. 6A shows how a screwing device according to the invention is being manipulated by hand into a position, for screwing a screw into a screw hole;

FIG. 6B shows the screwing device shown in FIG. 6A, in a configuration, in which the screwing device has been positioned in the desired position, for screwing a screw into its screw hole;

FIG. 6C shows a close-up view of the distal portion of the screwing device shown in FIG. 6A and in FIG. 6B;

FIG. 7A shows a screwing device according to the invention and

FIG. 7B shows a close-up view of a portion of the screwing device shown in FIG. 7A.

### DETAILED DESCRIPTION OF THE INVENTION

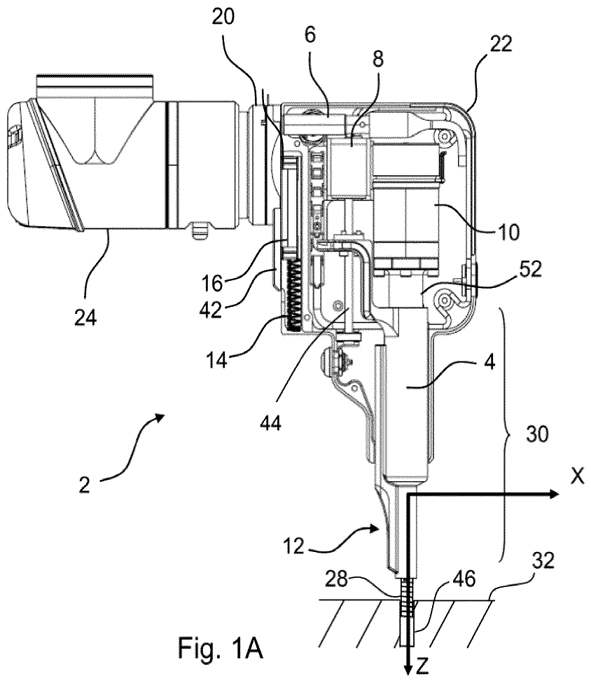

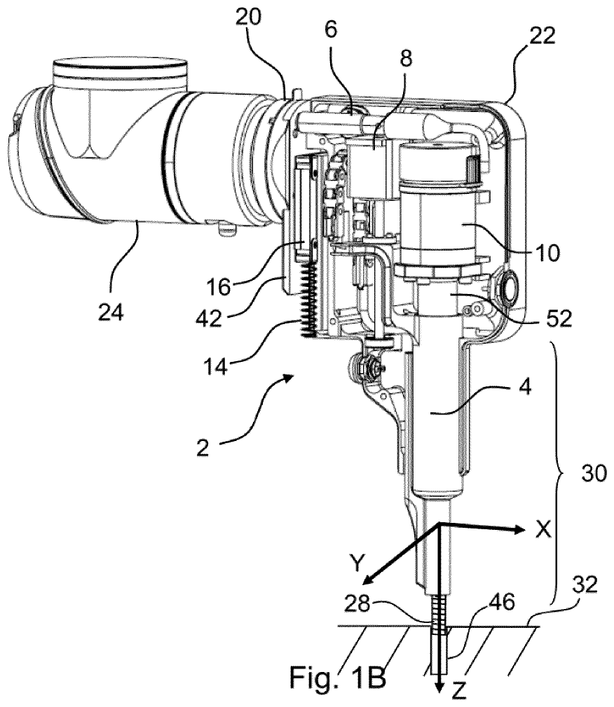

Referring now in detail to the drawings for the purpose of illustrating preferred embodiments of the present invention, a screwing device 2 of the present invention is illustrated in FIG. 1A and FIG. 1B.

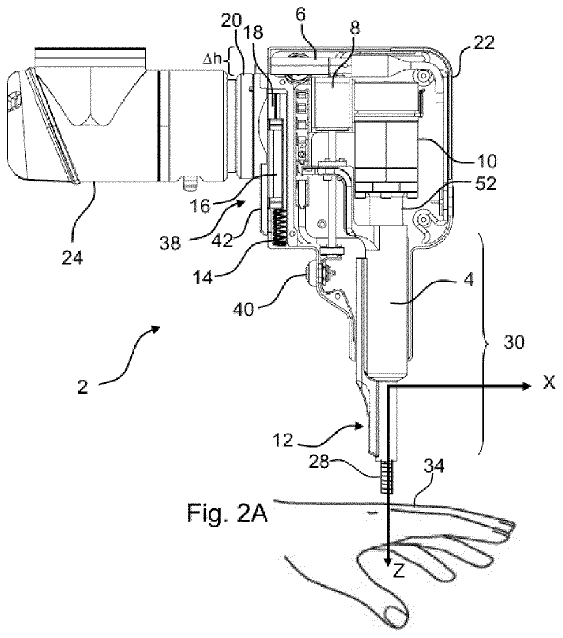

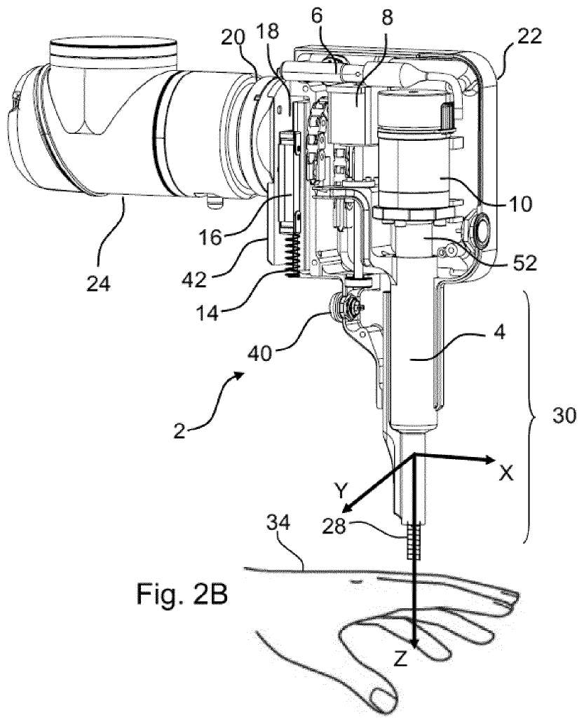

FIG. 1A is a side view of a screwing device 2 according to the invention in operation mode, whereas FIG. 1B illustrates a perspective side view of the screwing device 2 shown in FIG. 1B in operation mode. FIG. 2A illustrates a side view of the screwing device 2 according to the invention in a fail mode, in which the screwing device 2 has been deactivated. FIG. 2B illustrates a perspective side view of the screwing device 2 shown in FIG. 1A.

The screwing device 2 comprises a connection portion 42 configured to be detachably attached to a quick coupling 20. In FIG. 1A and FIG. 1B it can be seen that the quick coupling 20 is detachably attached to a robot arm 24.

In a preferred embodiment, the connection portion 42 configured to be detachably attached to a quick coupling 20. In one embodiment, however, the connection portion 42 may be configured to be detachably attached directly to the robot arm 24.

The screwing device 2 comprises a housing 22 and a safety sleeve 4 that is slidably arranged in the housing 22. The safety sleeve 4 can be displaced along the longitudinal axis Z of the screw holding portion 30 in order to prevent access to a screw 28 attached to the screw holding portion 30. The screwing device 2 comprises a motor 8 and a corresponding drive arrangement configured to displace the safety sleeve 4 can be displaced (both up and down) along the longitudinal axis Z of the screw holding portion 30.

The screwing device 2 comprises a slide member 16 that is rigidly attached to the coupling 20 that is attached to the robot arm 24. The housing 22 is slidably attached to the slide member 16. The slide member 16 is slidably mounted in a track 18 provided in the housing 22. Accordingly, the entire housing 22 can be displaced with respect to the slide member 16 and thus with respect to the robot arm 24.

One or more springs 14 are provided in the track 18. The spring(s) 14 are arranged to provide a force towards the slide member 16 hereby forcing the housing 22 downwards along the direction of the Z axis. Accordingly, the spring(s) provide force sufficiently large to maintain the screw 28 into engagement with the screw hole 46 so that the screw 28 can be screwed into the screw hole 46 of the first object 32.

The screwing device 2 comprises an alert unit configured to allow the screw holding portion 30 and the housing 22 to be passively moved away from the hand 34 if the screw holding portion 30 or the screw 28 held by the screw holding portion 30 is brought into contact with the hand 34. The alert unit comprises a safety sensor 6 electrically connected to the motor 10 and being configured to turn off the motor 10 when the screw holding portion 30 or a screw 28 held by the screw holding portion 30 is brought into contact with a second object 34 such as the hand 34 shown in FIG. 2A and FIG. 2B. The screwing device 2 comprises a shaft mechanically connected to the motor 10 and to the screw holding portion 30. Accordingly, the motor 10 is arranged to rotate the screw holding portion 30 and hereby screw a screw 28 into a screw hole 46 or remove the screw from the screw hole 48.

In one embodiment, the safety sensor 6 is an inductive sensor configured to register when the distal portion of the sensor 6 is within close proximity of metal (as shown in FIG. 1A and in FIG. 1B). When the housing 22 is displaced along the longitudinal axis Z of the screw holding portion 30 into the configuration illustrated in FIG. 2A and FIG. 2B, however, the distal portion of the sensor 6 is no longer within close proximity of the metal of the coupling 20. Accordingly, in FIG. 2A and FIG. 2B, the sensor 6 will initiate a process causing that the motor 10 rotating the screw holding portion 30 will be turned off. Turning off the motor 10 can be accomplished by sending instructions to the control system (not shown) of the robot arm 24 so that the control system of the robot arm 24 can electrically disconnect the motor 10 from its power source. In another embodiment, the screwing device 2 may be provided with a control unit configured to electrically disconnect the motor 10 from its power source when the distal portion of the sensor 6 is no longer within close proximity of the metal of the coupling 20. In one embodiment, the motor 10 is a gear motor.

In FIG. 2A and FIG. 2B the screw 28 and the screw holding portion 30 as well as the housing 22 has been retracted (displaced upwards along the longitudinal axis Z of the screw holding portion 30) compared with the configuration illustrated in FIG. 1A and FIG. 1B. Accordingly, the top portion of the housing 22 has been raised a distance Δh relative to the top portion of the coupling 20.

The screwing device 2 comprises a motor 8 and a corresponding drive arrangement configured to displace the safety sleeve 4 can be displaced (both up and down) along the longitudinal axis Z of the screw holding portion 30. In one embodiment, the motor 8 is a stepper motor.

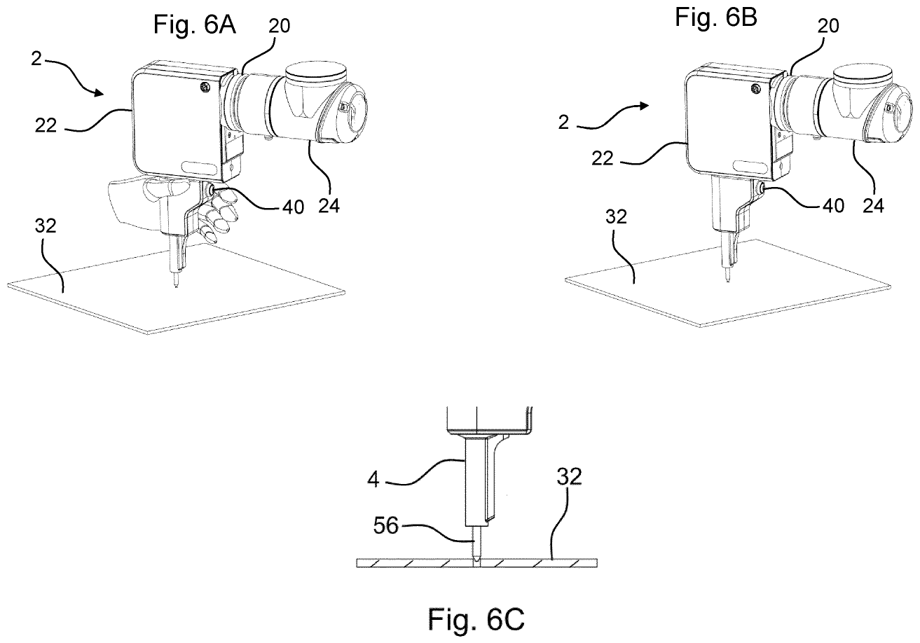

The screwing device 2 comprises a button 40 accessible from outside the housing 22. In a preferred embodiment, the button 40 is a press button. The button 40 is configured to bring the robot arm 24 into a free drive (neutral gear) mode, in which the screwing device 2 can be freely positioned within the range of motion of the robot arm 24 like illustrated in FIG. 6A.

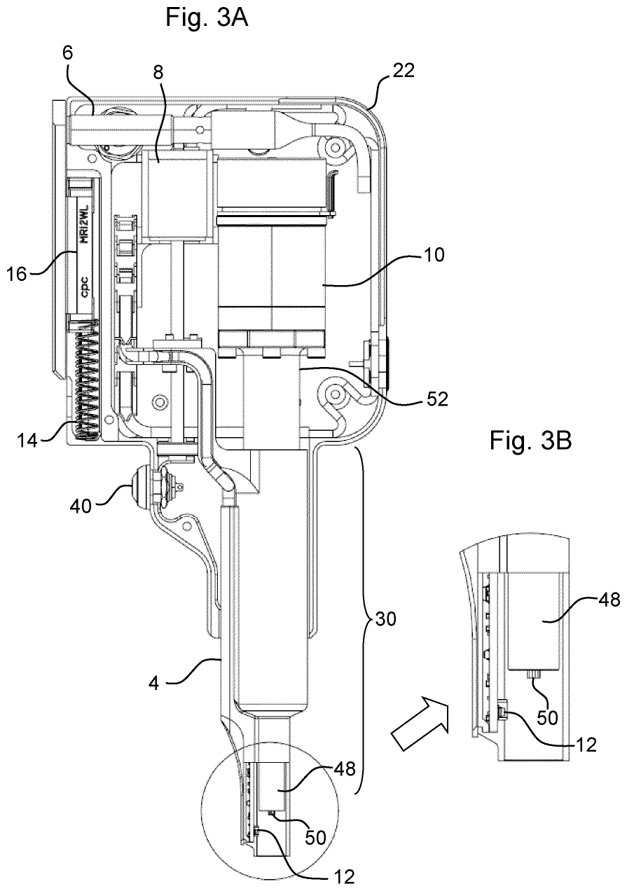

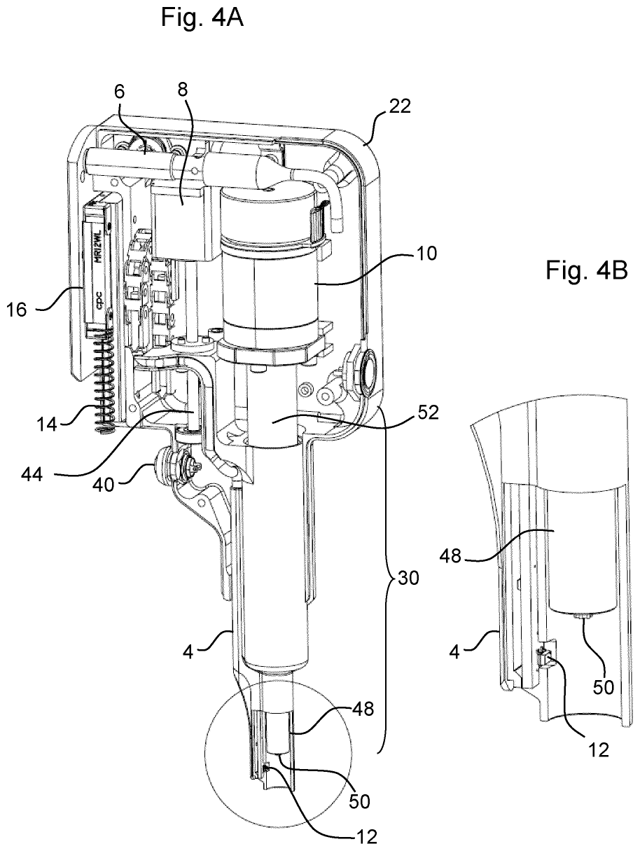

A Hall sensor 12 is arranged in the distal end of the safety sleeve 4. The Hall sensor 12 is arranged to detect the presence of a screw 28. This is further explained with reference to FIG. 3A, FIG. 3B, FIG. 4A and FIG. 4B.

FIG. 3A illustrates a side view of a screwing device 2 according to the invention. FIG. 3B illustrates a close-up view of the screwing device 2 shown in FIG. 3A. FIG. 4A illustrates a perspective side view of a screwing device 2 according to the invention. FIG. 4B illustrates a close-up view of the screwing device 2 shown in FIG. 4A.

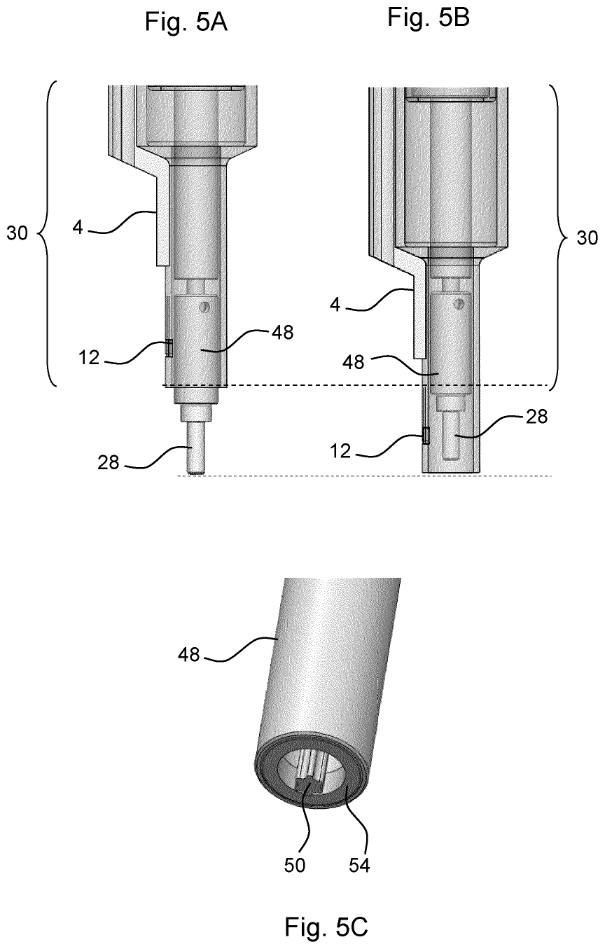

The screwing device 2 corresponds to the one shown in FIG. 1A, FIG. 1B, FIG. 2A and FIG. 2B. It can be seen that a Hall sensor 12 is provided in the distal portion of the safety sleeve 4. Moreover, a permanent magnet (shown in FIG. 5C) is provided in the distal end of the bit holder 48.

The Hall sensor 12 is configured to detect the magnet field transferred from a permanent magnet (shown in FIG. 5C) to the screw (shown in FIG. 5B).

The screwing device 2 is configured to displace the safety sleeve 4 to a position, in which the safety sleeve 4 covers the screw attached to and extending from the bit 50 when the Hall sensor 12 detects the present of a screw made in or comprising a magnetizable material ferromagnetic (e.g. iron, cobalt or nickel).

In a preferred embodiment, the screwing device 2 comprises a control unit configured to activate the motor 8 on the basis of the measurements made by the Hall sensor 12. On a preferred embodiment, the control unit is configured to keep the safety sleeve 4 in a position in which the safety sleeve 4 covers the screw until the screw has been screwed almost entirely into its screw hole. The control unit is electrically connected to the motor 8 and to the Hall sensor 12.

FIG. 5A illustrates the distal portion of a screw holding portion 30 of a screwing device 2 according to the invention in a first configuration. FIG. 5B illustrates the distal portion of a screw holding portion 30 of a screwing device 2 according to the invention in a second configuration. FIG. 5C illustrates a close-up perspective view of the distal portion of the bit holder 48 of the screw holding portion 30 shown in FIG. 5A and FIG. 5B.

The screwing device 2 corresponds to the one shown in the previous figures. In FIG. 5A, the safety sleeve 4 does not cover the screw 28 attached to the bit holder 50. In FIG. 5B, however, the safety sleeve 4 covers the screw 28 attached to the bit holder 50.

FIG. 5C illustrates that the bit holder 48 of the screw holding portion 30 comprises a cylindrical portion provided with a permanent magnet 54 arranged at the distal end of the inside portion of the cylindrical portion. The cylindrical portion comprises a centrally arranged bit holder 50 configured to receive and be brought into engagement with a screw head.

FIG. 6A illustrates how a screwing device 2 according to the invention is being manipulated by hand into a position, for screwing a screw into a screw hole. FIG. 6B illustrates the screwing device 2 shown in FIG. 6A, in a configuration, in which the screwing device 2 has been positioned in the desired position, for screwing a screw into its screw hole. The screwing device 2 is attached to a robot arm 24 via a coupling 20. FIG. 6C illustrates a close-up view of the distal portion of the screwing device 2 shown in FIG. 6A and in FIG. 6B.

The screwing device 2 comprises a press button 40 that is configured to bring the robot arm 24 into a free drive (neutral gear) mode, in which the operator manually can position the screwing device 2 within the range of motion of the robot arm 24.

In FIG. 6C a pointed positioning tool 56 is placed in the distal portion of the screw holding portion 30. Once the screwing device 2 has been positioned in the desired position, the screwing device 2 will register and communicate the registered position the robot arm (see FIG. 1A). The positioning tool 56 may now be replaced by a screw or the positioning tool 56 may be used to locate additional screw holes.

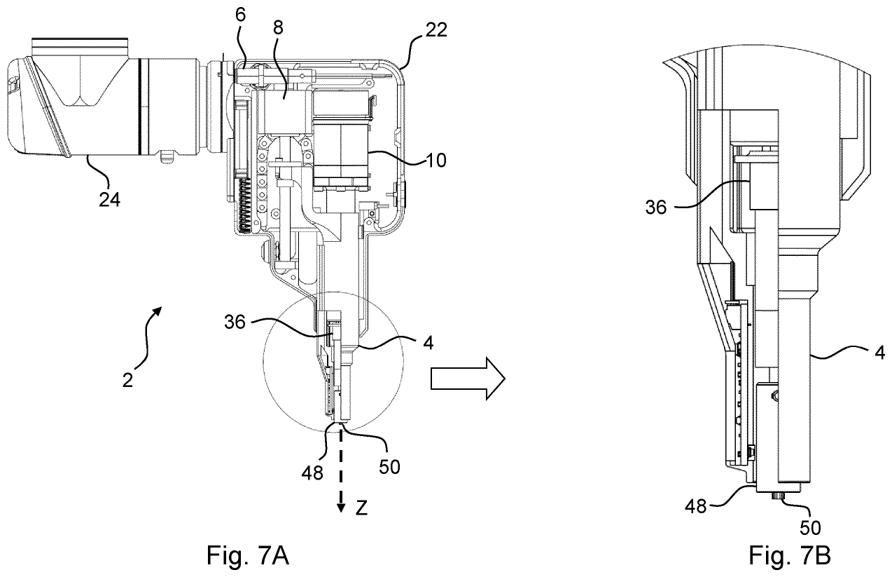

FIG. 7A illustrates a screwing device 2 according to the invention. FIG. 7B illustrates a close-up view of the proximal portion of the screw holding portion of the screwing device 2 shown in FIG. 7A.

The safety cover 4 has been displaced along the longitudinal axis Z of the screw holding portion and a handling mechanism 36 og the screwing device 2 is visible. The handling mechanism 36 is arranged and configured to bring the bit holder 48 into a locked configuration, in which a bit 50 inserted into the bit holder 48 can be maintained in a lockingly engagement with the bit holder 48.

The handling mechanism 36 is also arranged and configured to bring the bit holder 48 into an unlocked configuration, in which a bit 50 inserted into the bit holder 48 can be removed from the bit holder 48 (this is important when the bit 50 has to be replaced).

The safety cover 4 is shaped to mechanically engage with handling mechanism 36 and hereby perform a displacement of the handling mechanism 36 along the longitudinal axis Z of the screw holding portion. By providing a first predefined displacement, the safety cover 4 will bring the bit holder 48 into an unlocked configuration. Likewise, by providing another predefined displacement, the safety cover 4 will bring the bit holder 48 into a locked configuration.

### LIST OF REFERENCE NUMERALS

2 Screwing device
4 Safety sleeve
6 Safety sensor
8 Motor
10 Motor
12 Detection sensor
14 Spring
16 Slide member
18 Track
20 Coupling
22 Housing
24 Robot arm
28 Screw
30 Screw holding portion
32 First object
34 Second object
36 Handling mechanism
38 Linear translation unit
40 Button
42 Connection portion
44 Transfer unit
46 Screw hole
48 Bit holder
50 Bit
52 Shaft
54 Permanent magnet
56 Positioning tool
Δh Distance
X, Y, Z Axis

1. A screwing device comprising:
a connection portion configured to be detachably attached to a robot arm;
a housing;
a screw holding portion fixed to the housing, wherein the screw holding portion is configured to hold a screw in such a manner that the screw can be brought into contact with a screw hole of an object arranged in a predefined position;
a motor arranged to rotate the screw holding portion with respect to a longitudinal axis of movement of the screw holding portion;
an alert unit configured to allow the screw holding portion to be moved away from a structure when a force by which the structure presses against the screw holding portion or the screw held by the screw holding portion exceeds a predefined level, wherein the alert unit is configured to bring the screwing device into a failure mode, in which the motor is turned off when the force exceeds the predefined level.

2. The screwing device according to claim 1, comprising a linear translation unit comprising a slide member slidably arranged in a track, wherein the slide member is rigidly attached to the robot arm.

3. The screwing device according to claim 2, wherein the track extends along the longitudinal axis of movement of the screw holding portion.

4. The screwing device according to claim 2, wherein the linear translation unit comprises a spring arranged to displace the slide member along a longitudinal axis of the track.

5. The screwing device according to claim 2, wherein the housing is slidably attached to the connection portion.

6. The screwing device according to claim 2, further comprising:
a slidably arranged safety sleeve configured to be moved along the longitudinal axis of movement of the screw holding portion;
a second motor; and
a mechanical transfer unit arranged in the housing, wherein the mechanical transfer unit is arranged to displace the safety sleeve along the longitudinal axis of movement of the screw holding portion.

7. The screwing device according to claim 2, wherein the motor, arranged to rotate the screw holding portion, is arranged in the housing.

8. The screwing device according to claim 2, further comprising a safety sensor arranged in the housing, wherein the safety sensor is arranged to detect when the safety sensor is displaced along the longitudinal axis of movement of the screw holding portion.

9. A method for using a screwing device, wherein the screwing device comprises:
a connection portion configured to be detachably attached to a robot arm to conduct a safe screwing operation;
a housing;
a screw holding portion fixed to the housing, wherein the screw holding portion is configured to hold a screw in such a manner that the screw can be brought into contact with a screw hole of an object arranged in a predefined position;
a motor arranged to rotate the screw holding portion with respect to a longitudinal axis of movement, wherein the method comprises:
allowing the screw holding portion to be moved away from a structure when a force by which the structure presses against the screw holding portion or the screw held by the screw holding portion exceeds a predefined level;
bringing the screwing device into a failure mode, in which the motor is turned off when the force exceeds the predefined level.

10. The method according to claim 9, further comprising moving the screw holding portion away from the structure by a linear translation unit comprising a slide member slidably arranged in a track, wherein the slide member is rigidly attached to the robot arm.

11. The method according to claim 9, further comprising applying a slidably arranged safety sleeve configured to be moved along the longitudinal axis of movement of the screw holding portion, wherein the screwing device comprises a second motor and a mechanical transfer unit arranged in the housing, wherein the mechanical transfer unit is arranged to displace the safety sleeve along the longitudinal axis of movement of the screw holding portion.

12. The method according to claim 9, further comprising applying a safety sensor arranged in the housing, wherein the safety sensor is arranged to detect when the safety sensor is displaced along the longitudinal axis of movement of the screw holding portion.

13. A screwing device comprising:
a connection portion configured to be detachably attached to a robot arm;
a housing;
a screw holding portion fixed to the housing, wherein the screw holding portion is configured to hold a screw in such a manner that the screw can be brought into contact with a screw hole of an object arranged in a predefined position;
a motor arranged to rotate the screw holding portion with respect to a longitudinal axis of movement of the screw holding portion;
a slidably arranged safety sleeve configured to be moved along the longitudinal axis of movement of the screw holding portion; and
a sensor configured to detect the presence of the screw in the screw holding portion is arranged in a distal end of the safety sleeve.

14. The screwing device according to claim 13, wherein the sensor is a Hall sensor.

15. The screwing device according to claim 13, wherein a permanent magnet is provided in the distal end of the screw holding portion.

16. The screwing device according to claim 15, wherein the screw holding portion comprises a bit holder that comprises a cylindrical portion, wherein a cylindrical permanent magnet is arranged inside the cylindrical portion.

17. The screwing device according to claim 13, further comprising a second motor arranged and configured to displace the safety sleeve configured to be moved along the longitudinal axis of movement of the screw holding portion.

18. The screwing device according to claim 17, wherein the second motor is a stepper motor.

19. The screwing device according to claim 14 further comprising a control unit electrically connected to the Hall sensor.

20. A method for using a screwing device, wherein the screwing device comprises:
a connection portion configured to be detachably attached to a robot arm to conduct a safe screwing operation;
a housing; and
a screw holding portion fixed to the housing, wherein the method comprises:
detecting if a screw is present in the screw holding portion.

21. The method according to claim 20, wherein the screwing device comprises a slidably arranged safety sleeve configured to be moved along a longitudinal axis of movement of the screw holding portion, wherein the method comprises detecting if the screw is present in the screw holding is carried out by a sensor arranged at a distal end of the safety sleeve.

22. The method according to claim 21, wherein the method comprises:
instructing the robot arm to move the screwing device into a position in which the screwing device can pick-up the screw if the sensor has detected that no screw is held by the screw holding portion; and
picking-up the screw.

23. The method according to claim 21, wherein the method comprises:
providing information about a length and/or material characteristics of the screw; and
positioning the safety sleeve into a position in which the sensor is expected to detect the present of the screw having the provided length and/or material characteristics.
